(19) United States
(12) Patent Application Publication
(10) Pub. No.: US 2013/0244476 A1
(43) Pub. Date: Sep. 19, 2013

(54) SELF-MANAGING CORD

(71) Applicant: Dominic Symons, Pasadena, CA (US)

(72) Inventor: Dominic Symons, Pasadena, CA (US)

(21) Appl. No.: 13/420,360

(22) Filed: Mar. 14, 2012

(51) Int. Cl. H01R 11/01

(52) U.S. Cl. 439/502

(57) ABSTRACT

The invention is a self-managing cord or cable and method for managing a self-managing cord that includes one or more permanently formed spiral coils within one section of a cord and one or more non-coiled sections. The one or more non-coiled sections of the cord are inserted into the coiled section(s) in order to wrap, bind, manage, or otherwise organize the cord as a whole. To use the self-managing cord, the user wraps or winds the coiled portion(s) of the cord around the non-coiled portion(s) to form an organized and self-secured bundle.

### FIELD OF THE INVENTION

The current invention relates generally to a self-managing cord or cable that does not use external devices or superfluous attachments for wrapping, binding, managing, or otherwise organizing the cord. More specifically, the invention is one or more permanently formed spiral coils within one section of a cord. The one or more non-coiled sections of the cord are inserted into the coiled section(s) in order to wrap, bind, manage, or otherwise organize the cord as a whole. To use the self-managing cord, the user wraps or winds the coiled portion(s) of the cord around the non-coiled portion(s) to form an organized and self-secured bundle.

### BACKGROUND OF THE INVENTION

Cords and cables have been used for centuries for both mechanical and electrical purposes. In order to aid in the organization of the cord when not in use and/or to enable easier storage of the cord when not in use, the method of permanent coiling of a cord was employed. A permanently coiled cord is a cord or cable that has a metal cable or wire that is surrounded by a plastic sheath. The permanently coiled cord if made from the following steps: (1) make or provide the interior wire or cable; (2) sheath the wire or cable in thermoplastic; (3) wind the sheathed wire or cable around a rod in a single layer (the diameter of the rod determines the interior diameter of the final coiled cord); (4) heat treatment; and (5) reverse winding, which provides the spring action.

Other than creating a permanently coiled cord, the current options for organizing electronic cords are limited to wrapping the cord around an object or itself to form a bundle, or using attachment mechanisms, which may be external to the cord or attached to the cord, such as hook and loop straps, clips, and assorted types of ties to secure a bundled cord. Each of these mechanisms have shortcomings such as being difficult to use, requiring an extra weighty object, becoming lost, and/or breaking.

Thus, what is needed is a simple mechanism and method for managing cords that will not break or get lost, and overcomes the limitations of the prior art.

### SUMMARY OF THE INVENTION

To minimize the limitations in the prior art, and to minimize other limitations that will become apparent upon reading and understanding the present specification, the present invention discloses a new and useful self-managing cord that includes one or more permanently formed spiral coils and one or more non-coiled sections. The one or more non-coiled sections of the cord are inserted into the coiled section(s) in order to wrap, bind, manage, or otherwise organize the cord as a whole. To use the self-managing cord, the user wraps or winds the coiled portion(s) of the cord around the non-coiled portion(s) to form an organized and self-secured bundle.

One embodiment of the invention is a self-managing cord comprised of: a cord; wherein said cord is comprised of: at least one coiled portion and at least one uncoiled portion. The coiled portion is permanently coiled such that if said at least one coiled portion is stretched it substantially retains a coiled shape when released. The coiled portion coils around said at least one uncoiled portion such that said cord is managed. The cord is preferably an electronics cord that is constructed from at least one wire, which is preferably sheathed in thermoplastic. The electronics cord may be a smartphone cord, a power cord, an extension cord, or an ear bud cord.

Another embodiment of the invention is a method of managing a self-managing cord the steps comprised of: providing a cord; wherein said cord is comprised of: at least one coiled portion and at least one uncoiled portion; wherein said at least one coiled portion is permanently coiled such that if said at least one coiled portion is stretched it substantially retains a coiled shape when released; coiling said at least one coiled portion coils around said at least one uncoiled portion such that said cord is organized. The cord is preferably an electronics cord that is constructed from at least one wire, which is preferably sheathed in thermoplastic. The electronics cord may be a smartphone cord, a power cord, an extension cord, or an ear bud cord.

The present invention may be a self-managing electronics cord of any diameter that includes permanently formed spiral coil(s) at one end, and the rest of the cord is of traditional construction and is flexible enough to be wrapped within the spiral coil.

A preferred embodiment of the invention is an electronic cord with permanently formed spiral coil(s) at one end as described above, with an over-mold of rubber-type material over the coiled portion to provide additional stiffness.

The coiled portion of the cord may consist of any number of coils, so long as those coils can wrangle and organize the non-coiled part of the cord.

The electronic cord may be used for any purpose, including as headphones, ear buds, USB, power, audio, extension cord, or transmission. Alternatively, the cord of the present invention may also be a non-electrical cord, such as a security cable or hydraulic cable.

It is an object of the present invention to provide a device and method for a self managing cord that includes a permanently coiled portion that manages an uncoiled portion.

It is an object of the present invention to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of a perspective view of one embodiment of the self-managing cord and shows the permanently coiled portion of the cord wrapped around an organized bundle of the un-coiled portion of the cord.

FIG. 2 is an illustration of a perspective view of one embodiment of the self-managing cord and shows the cord unorganized.

FIG. 3 is an illustration of a perspective view of one embodiment of the self-managing cord and shows the cord as an unorganized power recharging cord.

FIG. 4 is an illustration of a perspective view of one embodiment of the self-managing cord and shows the cord as an organized power recharging cord.

FIG. 5 is an illustration of a perspective view of one embodiment of the self-managing cord and shows the cord as an unorganized extension cord.

FIG. 6 is an illustration of a perspective view of one embodiment of the self-managing cord and shows the cord as an unorganized ear bud cord.

FIG. 7 is an illustration of a perspective view of one embodiment of the self-managing cord and shows the cord with an over-mold.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without some or all of these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the screen shot figures, and the detailed descriptions thereof, are to be regarded as illustrative in nature and not restrictive. Also, the reference or non-reference to a particular embodiment of the invention shall not be interpreted to limit the scope of the invention.

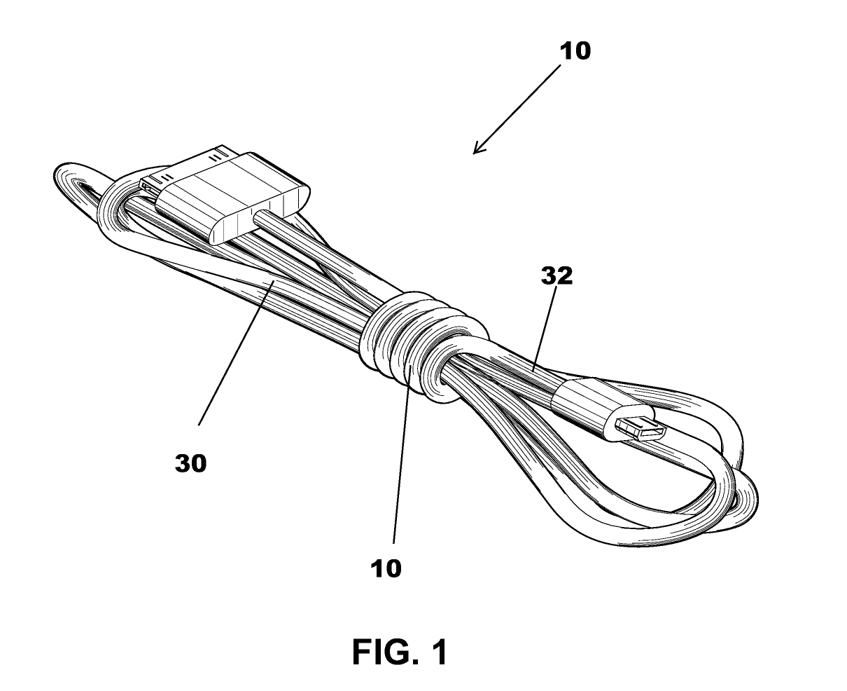

FIG. 1 is an illustration of a perspective view of one embodiment of the self-managing cord and shows the permanently coiled portion of the cord wrapped around an organized bundle of the un-coiled portion of the cord. FIG. 1 shows how the self-managing cord 10 preferably has at least one permanently coiled portion 20 and uncoiled portions 30 and 32. FIG. 1 shows how the uncoiled portion 30 is wrapped within the coiled portion 20. When the coiled portion 20 is wrapped around the uncoiled portion 30 the cord is organized in such a way that the cord is prevented from knotting or becoming tangled. Although FIG. 1 shows a specific type of electrical cord, it should be understood that the self-managing cord 10 may be any typed of cord, including, but not limited to: an electrical cord, a power cord, a recharging cord, a security cable, hose, hydraulic hose, bike lock cable, transmission cable, amplification cable, input cable, output cable, headphone cords, earphone cords, ear buds, power strip cords, speaker cables, smart phone connector cables, and/or synchronization cables. Although self-managing cord 10 is preferably an electrical wire cord or cable that is sheathed in flexible plastic, the self-managing cord need not have a metal cable or wire in its interior.

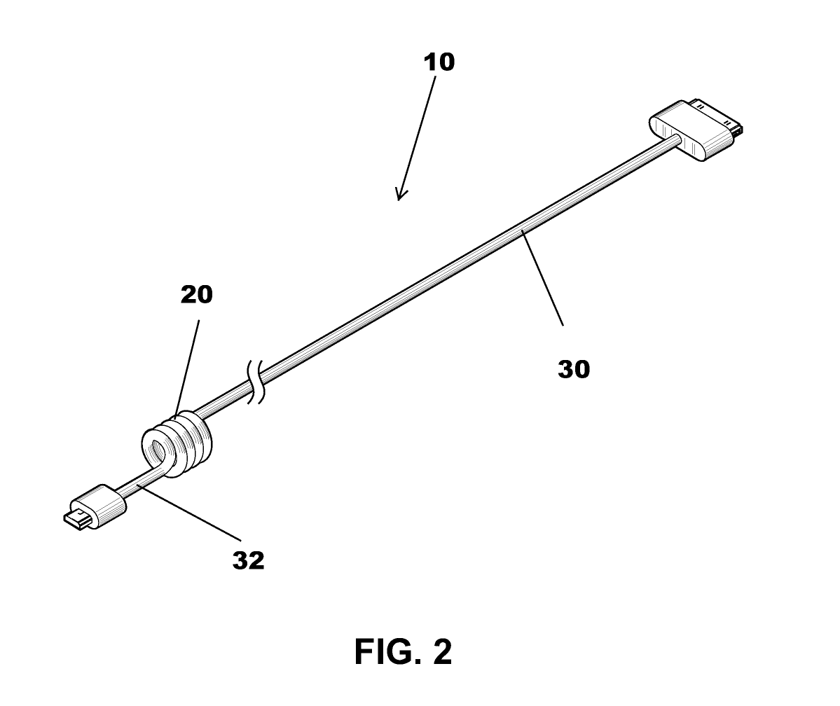

FIG. 2 is an illustration of a perspective view of one embodiment of the self-managing cord and shows the cord unorganized. FIG. 2 shows how the self-managing cord 10 has at least one coiled portion 20 and uncoiled portions 30 and 32. FIG. 2 shows how each of the coiled portions 20 are designed to coil around the uncoiled portion 30. FIG. 2 shows how the self-managing cord preferably has two lengths of uncoiled portion 30 and 32, which extend from either side of the coiled portion 20. FIG. 2 also shows how the uncoiled portion 30 is preferably longer than the coiled portion 20, such that coiled portion 20 is primarily used as an integrated cord management tool. Preferably, the longer that uncoiled portion 30 is, the more loops coiled portion 20 has and the greater the inner diameter of the loops of the coiled portion 20. In this manner coiled portion 20 is preferably designed to specifically manage the adjacent uncoiled portion 30. Any number of loops of coiled portion 20 may be used without deviating from the scope of the invention.

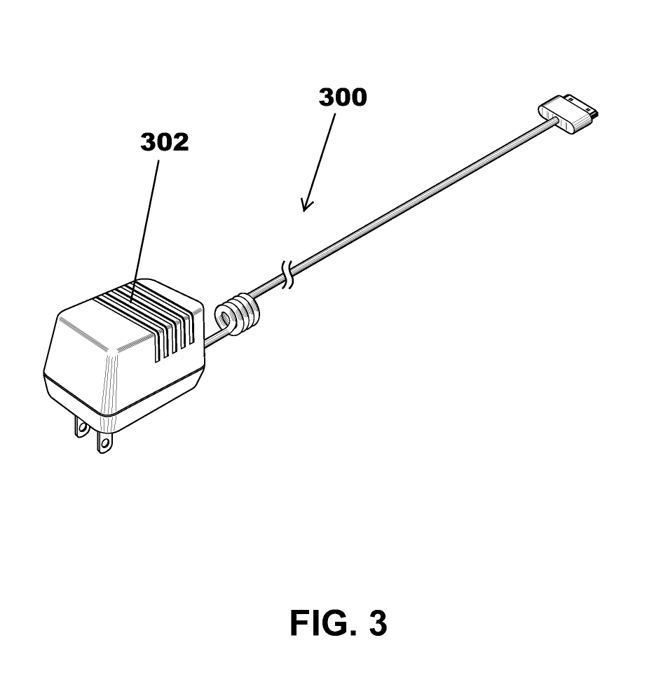

FIG. 3 is an illustration of a perspective view of one embodiment of the self-managing cord and shows the cord as an unorganized power recharging cord. FIG. 3 shows how the self-managed cord 300 may be a power cord 302.

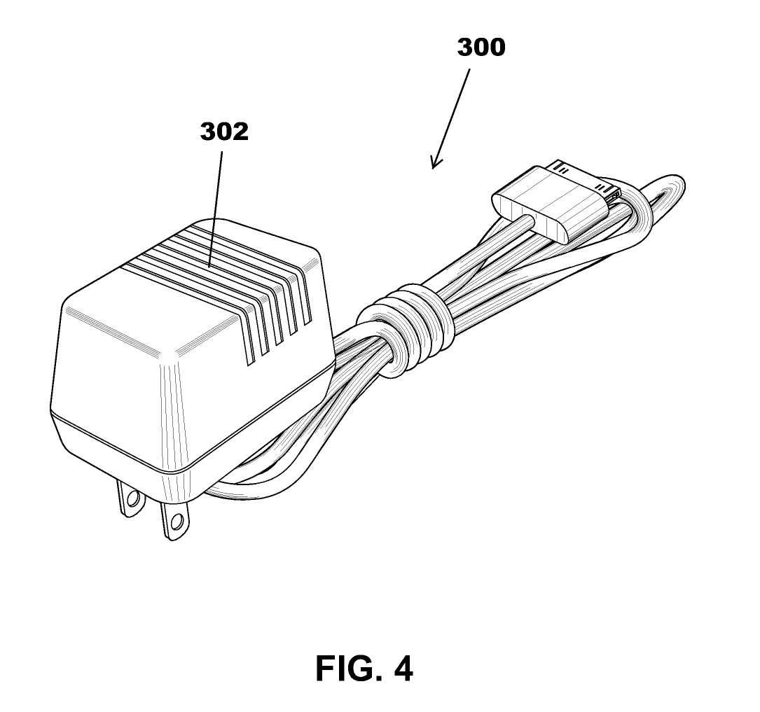

FIG. 4 is an illustration of a perspective view of one embodiment of the self-managing cord and shows the cord as an organized power recharging cord. FIG. 4 shows how the self-managed cord 300 may be a power cord 302.

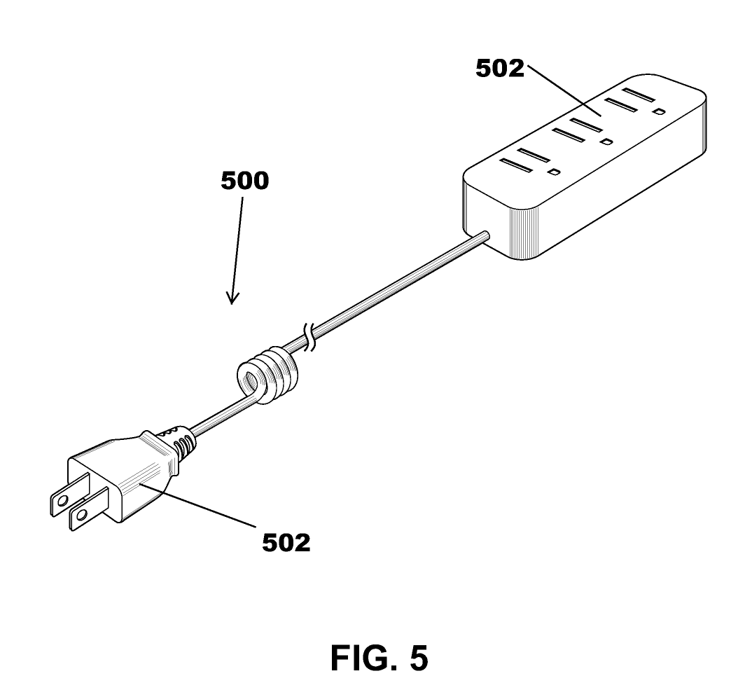

FIG. 5 is an illustration of a perspective view of one embodiment of the self-managing cord and shows the cord as an unorganized extension cord. FIG. 5 shows how the self-managed cord 500 may be a extension cord 502.

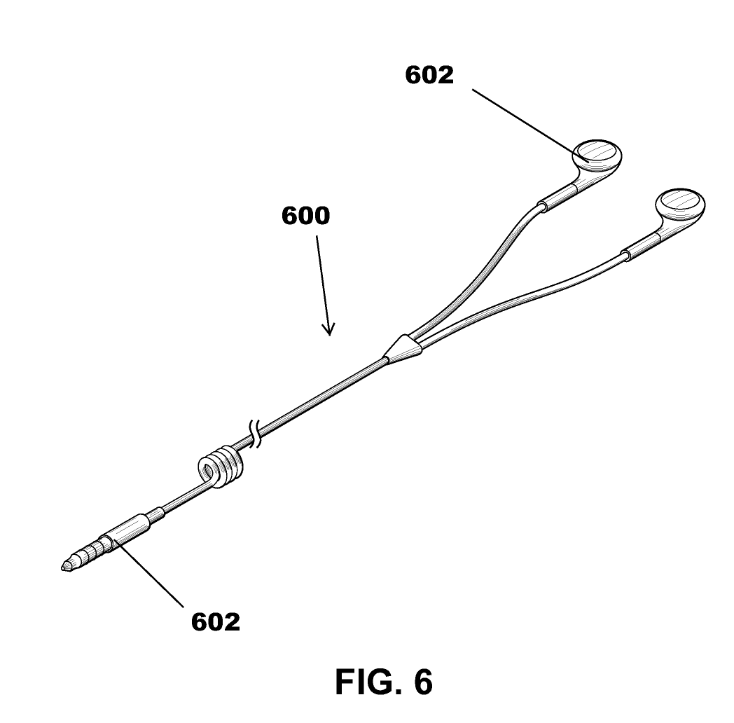

FIG. 6 is an illustration of a perspective view of one embodiment of the self-managing cord and shows the cord as an unorganized ear bud cord. FIG. 6 shows how the self-managed cord 600 may be an ear bud cord 602.

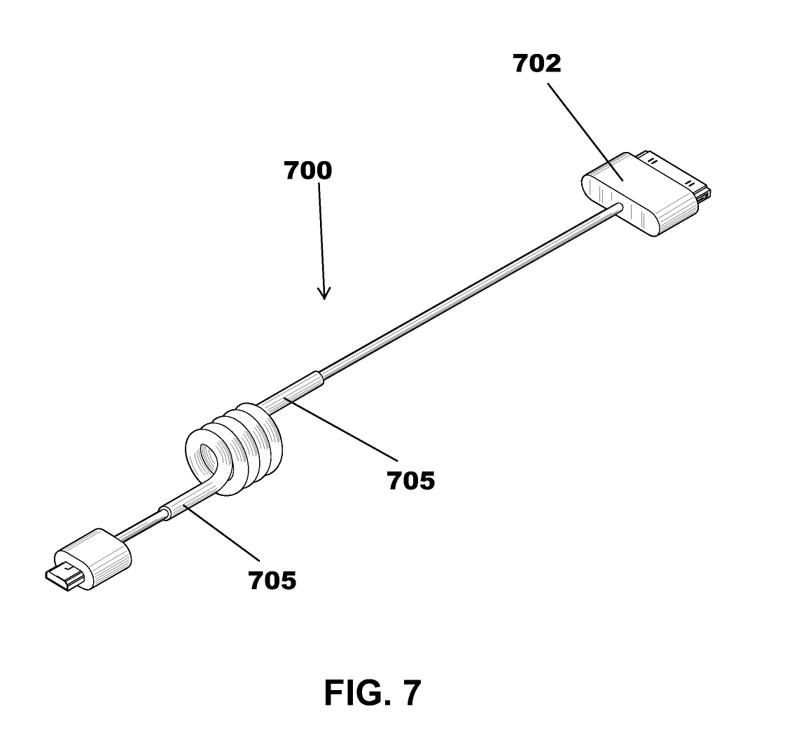

FIG. 7 is an illustration of a perspective view of one embodiment of the self-managing cord and shows the cord with an over-mold. FIG. 7 shows how the self-managed cord 700 may be a smartphone connector cord 702 wherein the coiled section has an over-mold 705. The over-mold 705 is preferably made from rubber or plastic and provides additional stiffness and support to the coiled section.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

What is claimed is:

1. A self-managing cord comprised of:
a cord;
wherein said cord is comprised of: at least one coiled portion and at least one uncoiled portion;
wherein said at least one coiled portion is permanently coiled such that if said at least one coiled portion is stretched it substantially retains a coiled shape when released;
wherein said at least one coiled portion coils around said at least one uncoiled portion such that said cord is managed.

2. The self-managing cord of claim 1, wherein said cord is an electronics cord that is constructed from at least one wire;
wherein said wire is sheathed in thermoplastic.

3. The self-managing cord of claim 2, wherein said at least one uncoiled portion is longer than said coiled portion.

4. The self-managing cord of claim 3, wherein said electronics cord is a smartphone cord.

5. The self-managing cord of claim 3, wherein said electronics cord is a power cord.

6. The self-managing cord of claim 3, wherein said electronics cord is an extension cord.

7. The self-managing cord of claim 3, wherein said electronics cord is an ear bud cord.

8. A method of managing a self-managing cord the steps comprised of:
providing a cord;
wherein said cord is comprised of: at least one coiled portion and at least one uncoiled portion;
wherein said at least one coiled portion is permanently coiled such that if said at least one coiled portion is stretched it substantially retains a coiled shape when released;
coiling said at least one coiled portion coils around said at least one uncoiled portion such that said cord is organized.

9. The self-managing cord of claim 8, wherein said cord is an electronics cord that is constructed from at least one wire;
wherein said wire is sheathed in thermoplastic.

10. The self-managing cord of claim 9, wherein said at least one uncoiled portion is longer than said coiled portion.

11. The self-managing cord of claim 9, wherein said electronics cord is a smartphone cord.

12. The self-managing cord of claim 9, wherein said electronics cord is a power cord.

13. The self-managing cord of claim 9, wherein said electronics cord is an extension cord.

14. The self-managing cord of claim 9, wherein said electronics cord is an ear bud cord.
